(19) United States
(12) Patent Application Publication
(10) Pub. No.: US 2025/0045443 A1
(43) Pub. Date: Feb. 6, 2025

(54) DATA MANAGEMENT METHOD, SYSTEM, AND DEVICE

(71) Applicant: HUAWEI TECHNOLOGIES CO., LTD., Shenzhen (CN)

(72) Inventors: Mingyu ZHAO, Shanghai (CN); Xueqiang YAN, Shanghai (CN); Bo LI, Shenzhen (CN); Yan XI, Shanghai (CN); Yang WANG, Shenzhen (CN); Weijun XING, Shanghai (CN)

(21) Appl. No.: 18/921,098

(22) Filed: Oct. 21, 2024

Related U.S. Application Data
(63) Continuation of application No. PCT/CN2023/083514, filed on Mar. 23, 2023.

(30) Foreign Application Priority Data
Apr. 22, 2022 (CN) 202210429732.7

(51) Int. Cl. G06F 21/62; G06F 16/23

(52) U.S. Cl. CPC G06F 21/6218; G06F 16/2379

(57) ABSTRACT

A data management method, a system, and a device are provided. An example method includes: A data storage entity receives a data access request and sends an access permission verification request to a distributed ledger node storing a data access policy of the client and/or a data access policy of the user. The distributed ledger node verifies, based on an identifier of a client and/or an identifier of a user in the access permission verification request and a distributed ledger, whether the client has data access permission, and sends a first access permission verification response to the data storage entity if the client has the data access permission, where the first access permission verification response indicates that the client has the data access permission. After receiving the first access permission verification response sent from the distributed ledger node, the data storage entity sends corresponding data to the client.

### CROSS-REFERENCE TO RELATED APPLICATIONS

This application is a continuation of International Application No. PCT/CN2023/083514, filed on Mar. 23, 2023, which claims priority to Chinese Patent Application No. 202210429732.7, filed on Apr. 22, 2022. The disclosures of the aforementioned applications are hereby incorporated by reference in their entireties.

### TECHNICAL FIELD

This application relates to the field of communication technologies, and in particular, to a data management method, a system, and a device.

### BACKGROUND

User data management is one of the most core functions of a mobile communication network. Both provision of a user service and normal operation of the network depend on a user data management entity and a related procedure. A user data management entity of the mobile network stores data related to a user and service subscription, key information, and the like, and is a key to implementing user authentication, authorization, and access control. Because a distributed ledger has features such as anti-tampering, decentralization, and multi-party participation, trust costs generated in a centralized structure can be effectively reduced. People usually select a distributed ledger platform as the user data management entity. For example, before performing data access, a client needs to verify permission through the distributed ledger platform.

Because an access interface for permission verification is opened, before performing data access, a large quantity of clients need to first access the distributed ledger platform to verify whether the clients have access permission. Because the large quantity of clients need to perform data access repeatedly for a plurality of times, the access interface for permission verification of the distributed ledger platform receives a large quantity of data access permission verification requests. Based on the method, the distributed ledger platform is vulnerable to a network attack, and security of data access performed by the client is reduced. Therefore, how to improve the security of data access performed by the client is an urgent problem to be resolved.

### SUMMARY

Embodiments of this application provide a data management method, a system, and a device, to help improve security of data access performed by a client.

According to a first aspect, an embodiment of this application provides a data management system. The system includes a client, a data storage entity, and a distributed ledger node.

The client is configured to send a data access request to the data storage entity, where the data access request carries an identifier of the client and/or an identifier of a user logging in to the client.

The data storage entity is configured to: after receiving the data access request sent from the client, generate an access permission verification request based on the data access request, and send the access permission verification request to the distributed ledger node, where the access permission verification request is for verifying whether the client has data access permission, and the access permission verification request carries the identifier of the client and/or the identifier of the user logging in to the client.

The distributed ledger node is configured to: after receiving the access permission verification request sent from the data storage entity, verify, based on the identifier of the client and/or the identifier of the user logging in to the client and a distributed ledger, whether the client has the data access permission, where the distributed ledger stores a data access policy of the client and/or a data access policy of the user.

The distributed ledger node is further configured to send a first access permission verification response to the data storage entity if the client has the data access permission, where the first access permission verification response indicates that the client has the data access permission.

The data storage entity is further configured to: after receiving the first access permission verification response sent from the distributed ledger node, send corresponding data to the client.

Based on the system described in the first aspect, when requesting data access, the client does not need to verify, through a distributed ledger platform, whether the client has the access permission. Instead, the client sends the data access request to the data storage entity, and the data storage entity requests the distributed ledger to verify whether the client has the access permission. In a data access process, the client cannot directly exchange data with the distributed ledger platform through an interface. Therefore, a network attack on the distributed ledger platform can be avoided, thereby helping improve security of data access performed by the client.

In a possible implementation, the data storage entity is further configured to send a data return success message to the distributed ledger node, where the data return success message carries data access transaction information of the client. The distributed ledger node is further configured to: after receiving the data return success message sent by the data storage entity, record the data access transaction information of the client in the distributed ledger. Based on this implementation, the distributed ledger platform may store, through the distributed ledger, transaction information of data access performed by each client, so that the distributed ledger platform can better perform data management subsequently.

In a possible implementation, when generating the access permission verification request based on the data access request, the data storage entity is specifically configured to generate the access permission verification request based on a smart contract and the data access request. When sending the first access permission verification response to the data storage entity, the distributed ledger node is specifically configured to: generate the first access permission verification response based on the smart contract, and send the first access permission verification response to the data storage entity. Based on this implementation, the security of data access performed by the client can be improved.

In a possible implementation, the distributed ledger node is further configured to send a second access permission verification response to the data storage entity if the client does not have the data access permission, where the second access permission verification response indicates that the client does not have the data access permission.

In a possible implementation, the client is further configured to send a data update request to the data storage entity, where the data update request carries the identifier of the client and/or the identifier of the user logging in to the client. The data storage entity is further configured to: after receiving the data update request sent from the client, generate an update permission verification request based on the data update request, and send the update permission verification request to the distributed ledger node, where the update permission verification request is for verifying whether the client has data update permission, and the update permission verification request carries the identifier of the client and/or the identifier of the user logging in to the client. The distributed ledger node is further configured to: after receiving the update permission verification request sent from the data storage entity, verify, based on the identifier of the client and/or the identifier of the user logging in to the client and the distributed ledger, whether the client has the data update permission, where the distributed ledger stores a data update policy of the client and/or a data update policy of the user. The distributed ledger node is further configured to send a first update permission verification response to the data storage entity if the client has the data update permission, where the first update permission verification response indicates that the client has the data update permission. The data storage entity is further configured to: after receiving the first update permission verification response sent from the distributed ledger node, update the data corresponding to the client. Based on this implementation, the client can flexibly update data in the data storage entity. In a data update process, the client cannot directly exchange data with the distributed ledger platform through an interface. Therefore, a network attack on the distributed ledger platform can be avoided, thereby helping improve security of data update performed by the client.

According to a second aspect, an embodiment of this application provides a data management method. The method includes: A data storage entity receives a data access request sent from a client. The data storage entity generates an access permission verification request based on the data access request, and sends the access permission verification request to a distributed ledger node, where the access permission verification request is for verifying whether the client has data access permission, and the access permission verification request carries an identifier of the client and/or an identifier of a user logging in to the client. The data storage entity receives a first access permission verification response sent from the distributed ledger node, where the first access permission verification response indicates that the client has the data access permission. The data storage entity sends corresponding data to the client. For beneficial effects of the second aspect, refer to the content described in the first aspect.

In a possible implementation, the data storage entity sends a data return success message to the distributed ledger node, where the data return success message carries data access transaction information of the client.

In a possible implementation, when the data storage entity generates the access permission verification request based on the data access request, a specific implementation is: The data storage entity generates the access permission verification request based on a smart contract and the data access request.

In a possible implementation, the method further includes: The data storage entity receives a data update request sent from the client. The data storage entity generates an update permission verification request based on the data update request, and sends the update permission verification request to the distributed ledger node, where the update permission verification request is for verifying whether the client has data update permission, and the update permission verification request carries the identifier of the client and/or the identifier of the user logging in to the client. The data storage entity receives a first update permission verification response sent from the distributed ledger node, where the first update permission verification response indicates that the client has the data update permission. The data storage entity updates the data corresponding to the client.

According to a third aspect, an embodiment of this application provides a data management method, where the method includes: A distributed ledger node receives an access permission verification request sent from a data storage entity, where the access permission verification request is for verifying whether a client has data access permission, and the access permission verification request carries an identifier of the client and/or an identifier of a user logging in to the client. The distributed ledger node verifies, based on the identifier of the client and/or the identifier of the user logging in to the client and a distributed ledger, whether the client has the data access permission, where the distributed ledger stores a data access policy of the client and/or a data access policy of the user. The distributed ledger node sends a first access permission verification response to the data storage entity if the client has the data access permission, where the first access permission verification response indicates that the client has the data access permission.

In a possible implementation, the distributed ledger node receives a data return success message sent by the data storage entity, where the data return success message carries data access transaction information of the client. The distributed ledger node records the data access transaction information of the client in the distributed ledger.

In a possible implementation, a specific implementation in which the distributed ledger node sends the first access permission verification response to the data storage entity if the client has the data access permission is: The distributed ledger node generates the first access permission verification response based on a smart contract if the client has the data access permission. The distributed ledger node sends the first access permission verification response to the data storage entity.

In a possible implementation, the method further includes: The distributed ledger node sends a second access permission verification response to the data storage entity if the client does not have the data access permission, where the second access permission verification response indicates that the client does not have the data access permission.

In a possible implementation, the method further includes: The distributed ledger node receives an update permission verification request sent from the data storage entity, where the update permission verification request is for verifying whether the client has data update permission, and the update permission verification request carries the identifier of the client and/or the identifier of the user logging in to the client. The distributed ledger node verifies, based on the identifier of the client and/or the identifier of the user logging in to the client and the distributed ledger, whether the client has the data update permission, where the distributed ledger stores a data update policy of the client and/or a data update policy of the user. A first update permission verification response is sent to the data storage entity if the client has the data update permission, where the first update permission verification response indicates that the client has the data update permission.

According to a fourth aspect, this application provides a communication apparatus. The apparatus may be a data storage entity, may be an apparatus in the data storage entity, or may be an apparatus that can be used together with the data storage entity. The communication apparatus may alternatively be a chip system. The communication apparatus may perform the method according to the second aspect. A function of the communication apparatus may be implemented by hardware, or may be implemented by executing corresponding software by hardware. The hardware or the software includes one or more units or modules corresponding to the foregoing functions. The unit or the module may be software and/or hardware. For operations performed by the communication apparatus and beneficial effects thereof, refer to the method in the second aspect and the beneficial effects thereof. Repeated parts are not described again.

According to a fifth aspect, this application provides a communication apparatus. The apparatus may be a distributed ledger node, may be an apparatus in the distributed ledger node, or may be an apparatus that can be used together with the distributed ledger node. The communication apparatus may alternatively be a chip system. The communication apparatus may perform the method in the third aspect. A function of the communication apparatus may be implemented by hardware, or may be implemented by executing corresponding software by hardware. The hardware or the software includes one or more units or modules corresponding to the foregoing functions. The unit or the module may be software and/or hardware. For operations performed by the communication apparatus and beneficial effects thereof, refer to the method in the third aspect, and the beneficial effects thereof. Repeated content is not described again.

According to a sixth aspect, this application provides a communication apparatus. The communication apparatus includes a processor. When the processor invokes a computer program in a memory, the method according to any one of the second aspect or the third aspect is performed.

According to a seventh aspect, this application provides a communication apparatus. The communication apparatus includes a processor and an interface circuit. The interface circuit is configured to: receive a signal from a communication apparatus other than the communication apparatus and transmit the signal to the processor, or send a signal from the processor to a communication apparatus other than the communication apparatus. The processor is configured to implement the method according to the second aspect or the third aspect by using a logic circuit or by executing code instructions.

According to an eighth aspect, this application provides a computer-readable storage medium. The storage medium stores a computer program or instructions. When the computer program or the instructions are executed by a communication apparatus, the method according to any one of the second aspect or the third aspect is implemented.

According to a ninth aspect, this application provides a computer program product including instructions. When a computer reads and executes the computer program product, the computer is enabled to perform the method according to any one of the second aspect or the third aspect.

### BRIEF DESCRIPTION OF DRAWINGS

To describe the technical solutions in embodiments of this application or in the prior art more clearly, the following briefly describes the accompanying drawings for describing embodiments or the prior art. It is clear that the accompanying drawings in the following descriptions show merely some embodiments of this application, and persons of ordinary skill in the art may still derive other drawings from these accompanying drawings without creative efforts.

FIG. 1 shows a possible 5G user data management architecture;

FIG. 2 shows a possible data management system based on a distributed ledger platform;

FIG. 3 is a diagram of a data management system according to an embodiment of this application;

FIG. 4 is a schematic flowchart of a data management method according to an embodiment of this application;

FIG. 5 shows a user data storage format according to an embodiment of this application;

FIG. 6 is a schematic flowchart of another data management method according to an embodiment of this application;

FIG. 7 is a diagram of a structure of a communication apparatus according to an embodiment of this application;

FIG. 8 is a diagram of a structure of another communication apparatus according to an embodiment of this application; and

FIG. 9 is a diagram of a structure of a chip according to an embodiment of this application.

### DESCRIPTION OF EMBODIMENTS

The following further describes specific embodiments of this application in detail with reference to the accompanying drawings.

Terms “first”, “second”, and the like in the specification, claims, and accompanying drawings of this application are for distinguishing between different objects, but are not for describing a specific order. In addition, terms “including” and “having” and any other variants thereof are intended to cover a non-exclusive inclusion. For example, a process, a method, a system, a product, or a device that includes a series of steps or units is not limited to the listed steps or units, but optionally further includes an unlisted step or unit, or optionally further includes another inherent step or unit of the process, the method, the product, or the device.

An “embodiment” mentioned in this specification means that particular features, structures, or characteristics described with reference to this embodiment may be included in at least one embodiment of this application. The phrase shown in various locations in the specification may not necessarily refer to a same embodiment, and is not an independent or optional embodiment exclusive from another embodiment. It is explicitly and implicitly understood by persons skilled in the art that embodiments described in this specification may be combined with another embodiment.

In this application, “at least one (item)” means one or more, “a plurality of” means two or more, “at least two (items)” means two, three, or more, and “and/or” is for describing a correspondence between associated objects and indicates that three relationships may exist. For example, “A and/or B” may indicate the following three cases: Only A exists, only B exists, and both A and B exist, where A and B may be singular or plural. The character “/” generally indicates an “or” relationship between the associated objects. The expression “at least one of the following items (pieces)” or a similar expression means any combination of these items, including a single item (piece) or any combination of a plurality of items (pieces). For example, at least one of a, b, or c may indicate a, b, c, a and b, a and c, b and c, or a, b, and c, where a, b, and c may be singular or plural.

The following further describes the background of embodiments of this application. User data management is one of the most core functions of a mobile communication network. Both provision of a user service and normal operation of the network depend on a user data management entity and a related procedure. In recent years, with increasing awareness of personal privacy protection of people, a user has an increasingly high requirement on data security. The user data management entity is a key to implementing user authentication, authorization, and access control. Therefore, ensuring security of the user data management entity is also a key to ensuring user data security.

FIG. 1 shows a possible 5G user data management architecture. The data management architecture includes unified data management (Unified Data Management, UDM), a unified data repository (Unified Data Repository, UDR), an access and mobility management function (access and mobility management function, AMF), a session management function (Session Management Function, SMF), an authentication server function (Authentication Server Function, AUSF), a short message service function (Short Message Service Function, SMSF), a network exposure function (Network Exposure Function, NEF), and a policy control function (Policy Control function, NEF).

In the user data management architecture, user data management entities are the UDM and the UDR. The UDM is mainly responsible for management of an identifier of a user, subscription data, and authentication data, and serving network element registration management of the user. The UDR is mainly responsible for storing user data such as customer configuration profile information, customer identity authentication information, and an encryption key for the information. The UDM has two versions: stateful UDM and stateless UDM. The stateful UDM stores data locally, and the stateless UDM stores data outside the UDR. The UDM manages data related to access authorization, user registration, and the like. Both the UDM and the UDR can send and store data. In a stateless network, information about the user is stored in the UDR, and the UDM is configured to: retrieve data and send the data to another network function.

In addition to the user data management entity, in the user data management architecture, the AMF is mainly responsible for accessing a network by a terminal device, authenticating an identity of the terminal device, and enabling the terminal device to move around and maintain a network connection. The SMF is mainly responsible for allocating an internet protocol (Internet Protocol, IP) address to the terminal device and managing each channel between the terminal device and a core network. The AUSF is mainly responsible for a request that the AMF performs identity authentication on the terminal device, requesting a key from the UDM, and then forwarding, to the AMF for authentication processing, the key delivered by the UDM. The SMSF is mainly responsible for providing registration, deregistration, and sending and receiving network attached storage (Network Attached Storage, NAS) short message services for a 5G terminal user. The NEF is mainly responsible for exposing a network capability to a third-party application, to implement friendly interconnection between the network capability and a service requirement, improve service experience, and optimize network resource configuration. The PCF can support a unified policy framework to manage network behaviors, provide a policy rule for a network entity for execution, and have subscription information for accessing the UDR.

In the user data management architecture described above, the UDM and the UDR are mainly responsible for data storage and policy management. However, the UDM and the UDR perform centralized data storage and centralized authentication and authorization, resulting in a possibility of a single point failure and a network attack. In addition, the user lacks control over personal data. Personal user data is centrally stored in a database of a network provider/service provider. The network provider/service provider can share user data with a third party without knowledge of the user, causing a huge risk of privacy leakage.

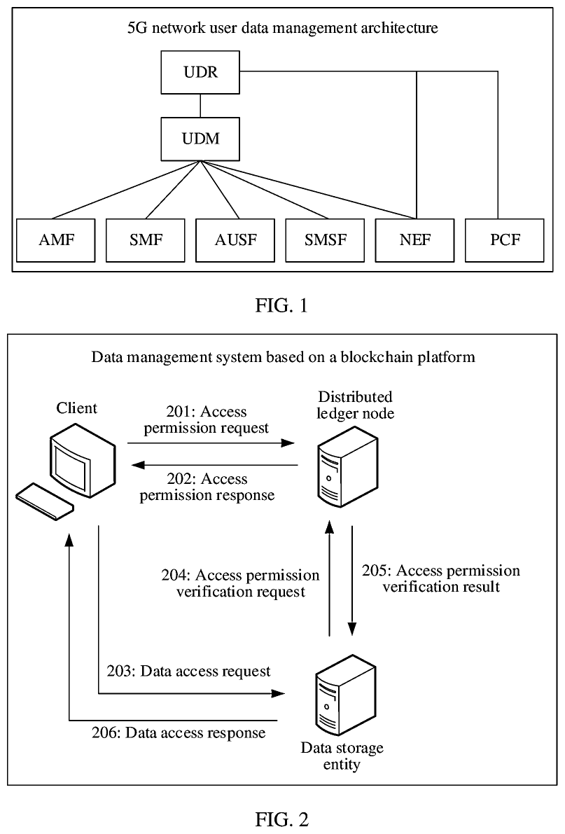

A distributed ledger (Distributed ledger Technology, DLT) is a database that is shared, replicated, and synchronized between network members. The distributed ledger records a transaction between network participants, for example, asset or data exchange. The distributed ledger has features such as anti-tampering, decentralization, and multi-party participation, and can effectively reduce trust costs generated in a centralized structure. People usually select a distributed ledger platform as the user data management entity. FIG. 2 shows a possible data management system based on a distributed ledger platform. The system includes a client, a distributed ledger node, and a data storage entity. The client is a data request entity and has a function of requesting data access. The distributed ledger node is a node device used by the distributed ledger platform to perform external data transmission. The distributed ledger platform corresponding to the distributed ledger node has a function of implementing authentication, authentication, authorization, and access control logic of data access. The data storage entity is configured to store data of an individual user. Optionally, in this embodiment of this application, a distributed ledger may be a blockchain, and the distributed ledger node may be a blockchain node.

The data management system based on the distributed ledger platform may implement a data access method shown in step 201 to step 206.

201: The client sends an access permission request to the distributed ledger node. Correspondingly, the distributed ledger node receives the access permission request sent from the client, where the access permission request carries an identifier of the user. The distributed ledger node determines, based on the identifier of the user, that the client has data access permission, and generates proof of permission.

202: The distributed ledger node sends an access permission response to the client. Correspondingly, the client receives the access permission response sent from the distributed ledger node, where the access permission response carries the proof of permission.

203: The client sends a data access request to the data storage entity. Correspondingly, the data storage entity receives the data access request sent from the client, where the data access request carries the proof of permission.

204: The data storage entity sends an access permission verification request to the distributed ledger node. Correspondingly, the distributed ledger node receives the access permission verification request sent from the data storage entity, where the access permission verification request carries the proof of permission. After verifying that the proof of permission is authentic and valid, the distributed ledger node generates an access permission verification result, where the access permission verification result indicates that the proof of permission is authentic and valid.

205: The distributed ledger node sends the access permission verification result to the data storage entity. Correspondingly, the data storage entity receives the access permission verification result sent from the distributed ledger node.

206: The data storage entity sends a data access response to the client. Correspondingly, the client receives the data access response sent from the data storage entity, where the data access response carries data that the client requests to access.

In some embodiments, reference may also be made to a user data management method described in Chinese Patent Application No. 202110790267.5, entitled “USER DATA MANAGEMENT METHOD AND RELATED DEVICE”.

However, with continuous development of the current era, a quantity of client devices is increasing. Based on the method corresponding to FIG. 2, because an access interface for permission verification between the client and the distributed ledger node is opened, before performing data access, a large quantity of clients need to first access the distributed ledger node to verify whether the clients have access permission. In addition, each time the client performs data access, verification of the distributed ledger node is required. The large quantity of clients usually need to perform data access repeatedly for a plurality of times. Therefore, the distributed ledger node receives a large quantity of access permission requests. In a process of the large quantity of access permission requests, several unauthorized devices may attack the distributed ledger platform in a manner such as a distributed denial of service (Distributed Denial of Service, DDOS) attack, causing a breakdown of a user management system and reducing security of user data. Therefore, how to improve security of data access performed by the client is an urgent problem to be resolved.

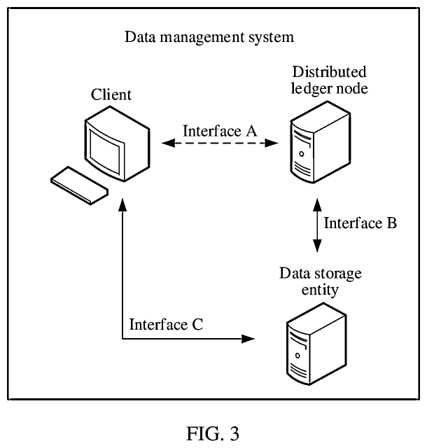

To improve the security of data access performed by the client, an embodiment of this application provides a data management system, as shown in FIG. 3. The data management system may include at least one client, at least one distributed ledger node, and at least one data storage entity. The data management system shown in FIG. 3 includes one client, one distributed ledger node, and one data storage entity. Quantities of clients, distributed ledger nodes, and data storage entities are not limited in this embodiment of this application.

The client is a network functional entity connected to the data storage entity in the data management system, and includes but is not limited to: a data subject (Data Subject, DS), a data control entity (Data Controller, DC), and a data processing entity (Data Processor, DP). The distributed ledger node is a node device used by a distributed ledger platform to perform external data transmission. The distributed ledger platform corresponding to the distributed ledger node has a function of implementing authentication, authentication, authorization, and access control logic of data access. The distributed ledger platform stores a distributed ledger. The distributed ledger is tamper-proof, and is for recording a data access record and a policy management record of the client for auditing. The data storage entity is configured to store data of an individual user.

The client may be a mobile phone (mobile phone), a personal computer (Personal Computer, PC), a wireless terminal in industrial control (industrial control), a vehicle-mounted terminal device, a wireless terminal in self-driving (self-driving), a wireless terminal in a smart grid (smart grid), a wearable terminal device, or the like. An application scenario is not limited in this embodiment of this application. A terminal sometimes may also be referred to as a terminal device, user equipment (user equipment, UE), an access terminal device, a vehicle-mounted terminal, a terminal in industrial control, a UE unit, a UE station, a mobile station, a remote station, a remote terminal device, a mobile device, a UE terminal device, a terminal device, a wireless communication device, a UE agent, a UE apparatus, or the like. Alternatively, the client may be a server. Specifically, the client may be an independent physical server, may be a server cluster or a distributed system including a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (Content Delivery Network, CDN), and a big data and artificial intelligence platform.

The distributed ledger node or the data storage entity may be a server. Specifically, the distributed ledger node or the data storage entity may be an independent physical server, may be a server cluster or a distributed system including a plurality of physical servers, or may be a cloud server that provides basic cloud computing services such as a cloud service, a cloud database, cloud computing, a cloud function, cloud storage, a network service, cloud communication, a middleware service, a domain name service, a security service, a CDN, and a big data and artificial intelligence platform.

It should be further noted that the data management system includes three interfaces: an interface A, an interface B, and an interface C. The interface A is an interface between the client and the distributed ledger node. In a data management method provided in an embodiment of this application, in a process in which the client performs data access, the client does not need to directly obtain proof of permission by using the distributed ledger node, but directly sends a data access request to the data storage entity. The data storage entity requests the distributed ledger node to verify the client, and the client does not directly exchange data with the distributed ledger node through the interface A. The interface A is mainly for implementing data exchange between the client and the distributed ledger node when a transaction of user registration, user deregistration, or policy management is performed. The interface B is an interface between the data storage entity and the distributed ledger node. The data storage entity requests, through the interface B, the distributed ledger node to perform verification and authorization on the client. The interface Cis an interface between the client and the data storage entity. The interface C is mainly for implementing the data access request and a data access response.

Based on the system described above, in the process in which the client performs data access, the client does not directly exchange data with the distributed ledger platform through the interface A. This avoids a case in which the distributed ledger node receives access permission requests sent from a large quantity of clients, so as to avoid a network attack on the distributed ledger platform. Compared with the quantity of clients, the quantity of data storage entities is greatly reduced, and security is high. The system can improve security of data access performed by the client.

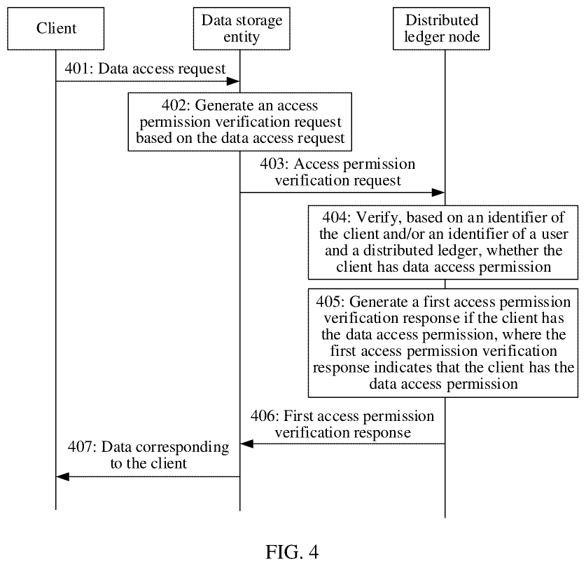

This application provides a data management method that is applicable to the data management system provided in FIG. 3. As shown in FIG. 4, the data management method includes step 401 to step 407. The method shown in FIG. 4 may be performed by a client, a distributed ledger node, and a data storage entity. Alternatively, the method shown in FIG. 4 may be performed by a chip in a client, a chip in a distributed ledger node, and a chip in a data storage entity. In FIG. 4, the client, the distributed ledger node, and the data storage entity are used as an example for description. Execution subjects of a subsequent flowchart follow the same principle. Details are not described subsequently.

401: The client sends a data access request to the data storage entity. Correspondingly, the data storage entity receives the data access request sent from the client.

In this embodiment of this application, the data access request indicates that the client requests to perform data access, and the data access request carries an identifier of the client and/or an identifier of a user, so that the data storage entity initiates an access permission verification request to the distributed ledger node based on the identifier of the client and/or the identifier of the user, to verify whether the client has data access permission. Optionally, the data access request may further carry a private key signature of the client and/or a data access policy of the client. Information carried in the data access request is mainly used by the distributed ledger node to determine an identity and the data access policy of the client, and indicate, according to the data access policy of the client, the data storage entity to return data corresponding to the client or reject the data access request.

The identifier of the user may be an identifier of a user logging in to the client, or may be an identifier of a user logging in to a target device. The target device authorizes the client to access personal data. Therefore, the client may access data corresponding to the user by carrying the identifier of the user logging in to the target device. It should be further noted that, if the client needs to access data of the target device, in addition to the identifier of the user of the target device, the data access request further needs to carry a digital signature corresponding to the user of the target device, to ensure data security.

It should be noted that the client does not need to verify, through a distributed ledger platform, whether the client has the access permission. Instead, the client sends the data access request to the data storage entity, and the data storage entity requests the distributed ledger platform to verify whether the client has the access permission. In a data access process, the client does not directly exchange data with the distributed ledger platform through an interface. Therefore, a case in which the distributed ledger node receives request information sent from a large quantity of clients is reduced, and a possibility of a network attack on the distributed ledger platform is reduced, thereby helping improve security of data access performed by the client. In addition, because the data access request not only indicates that the client requests access, but also indicates that the data storage entity is requested to initiate the access permission verification request to the distributed ledger node, to verify the identity of the client. The client no longer needs to send the access permission verification request to the distributed ledger node. This helps reduce a delay of data access performed by the client.

402: The data storage entity generates the access permission verification request based on the data access request.

In this embodiment of this application, the access permission verification request is for verifying whether the client has the data access permission, and the access permission verification request carries the identifier of the client and/or the identifier of the user. Optionally, if the data access request further carries the private key signature of the client and/or the data access policy of the client, the access permission verification request further carries the private key signature of the client and/or the data access policy of the client.

In a possible implementation, a specific implementation in which the data storage entity generates the access permission verification request based on the data access request is: The data storage entity generates the access permission verification request based on a smart contract and the data access request. The smart contract is a computer protocol intended to disseminate, verify, or execute a contract in an informatization manner. Rules proposed by the smart contract are open and transparent, and the rules and data in the contract are visible to the outside. The smart contract allows trusted transactions to be performed without a third party. These transactions are traceable and irreversible. Because the smart contract is traceable and irreversible, based on this implementation, security of data exchange between the data storage entity and the distributed ledger node can be improved.

403: The data storage entity sends the access permission verification request to the distributed ledger node. Correspondingly, the distributed ledger node receives the access permission verification request sent from the data storage entity.

In this embodiment of this application, when receiving a message that is sent from another device (the client or the data storage entity) and that is for requesting verification permission, the distributed ledger node first determines a type of a transaction based on the message, and then determines a control policy of a user or a control policy of a device in the distributed ledger based on an identifier of the user or an identifier of the device carried in the message, to determine whether the user or the device has corresponding permission on the transaction. Based on the method described in this application, the distributed ledger node receives the access permission verification request sent from the data storage entity, and the access permission verification request is generated based on the data access request sent by the client. Therefore, a transaction type corresponding to the access permission verification request is a data request. In addition to the data request, types of transactions that can be processed by the distributed ledger node further include: user registration, user deregistration, data update, policy management, and the like.

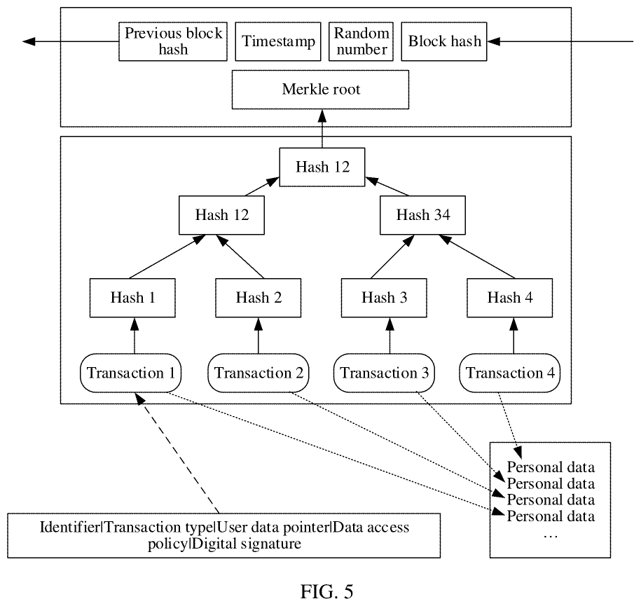

Transaction information is stored in the distributed ledger node, and the distributed ledger node determines a transaction type based on the transaction information and a message sent from another external device. A storage format of the transaction information is shown in FIG. 5. The transaction information is stored in the distributed ledger in a form of a block. Personal data of the user is stored off-chain in a form of a hash function. Specifically, the transaction information further includes an identifier, a transaction type, a user data pointer, a data access policy, and a digital signature. The user data pointer indicates a storage address of the personal data of the user, and the digital signature is for implementing authentication and ensure data security.

It should be further added that the user registration means that a client provides personal information to request the distributed ledger platform to register a user. After the distributed ledger platform determines the user, the data storage entity stores user data and an access control policy of the client. The user deregistration means that a client initiates a request to the distributed ledger node to deregister personal information, and the distributed ledger node sends a message to indicate the data storage entity to delete user data and an access control policy of the client. The policy management means that a client maintains a data access policy of the client through a customer-oriented management interface provided by a service provider. The data update means that a client requests to update user data stored in the data storage entity. Based on the system in FIG. 3, the following describes a general processing manner corresponding to each transaction type and an interface required in a processing process.

Interfaces required for the user registration include the interface A and the interface B. A specific processing manner is: The client sends, to the distributed ledger node through the interface A, a registration request that carries information about a user. After receiving the registration request, the distributed ledger node sends a registration indication message to the data storage entity through the interface B, where the registration indication message carries the information about the user and an access control policy corresponding to the user. The data storage entity stores the information about the user and the access control policy corresponding to the user.

Interfaces required for the user deregistration include the interface A and the interface B. A specific processing manner is: The client sends, to the distributed ledger node through the interface A, a deregistration request that carries information about a user. After receiving the deregistration request, the distributed ledger node sends a deregistration indication message to the data storage entity through the interface B, where the deregistration indication message carries the information about the user. After receiving the deregistration indication message, the data storage entity deletes data information corresponding to the user and an access control policy corresponding to the user.

An interface required for the policy management includes the interface A. A specific processing manner is: The client sends, to the distributed ledger node through the interface A, a policy management request that carries information about a user, where the policy management request indicates to adjust a control policy corresponding to the user. After receiving the policy management request, the distributed ledger node adjusts or maintains the control policy corresponding to the user based on the policy management request.

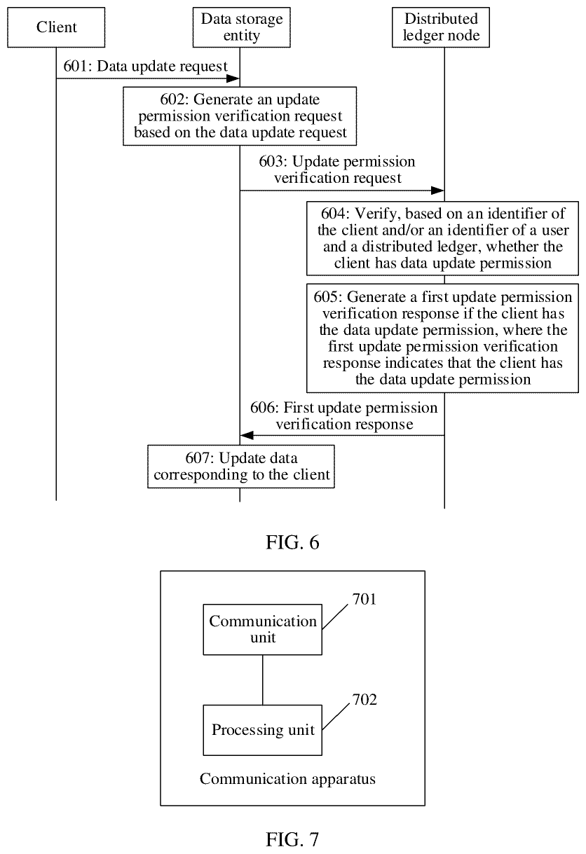

Interfaces required for the data update include the interface B and the interface C. For a processing procedure corresponding to the data update, refer to descriptions in FIG. 6. Details are not described in this embodiment of this application.

In some embodiments, reference may also be made to a transaction type described in Chinese Patent Application No. 202110626638.6, entitled “USER DATA MANAGEMENT METHOD AND RELATED DEVICE”.

404: The distributed ledger node verifies, based on the identifier of the client and/or the identifier of the user and a distributed ledger, whether the client has the data access permission.

In this embodiment of this application, the distributed ledger stores the data access policy of the client and/or a data access policy of the user. The distributed ledger node may be in one-to-one correspondence with information stored in the distributed ledger based on information carried in the access permission verification request. If the identifier of the client and/or the identifier of the user are/is completely the same as the information in the distributed ledger, and it is determined, in the data access policy, that the client has the data access permission, it is determined that the client has the data access permission. If the identifier of the client and/or the identifier of the user and the information in the distributed ledger have different content, or it is determined, in the data access policy, that the client does not have the data access permission, it is determined that the client does not have the data access permission.

The distributed ledger is tamper-proof. Because the distributed ledger stores the data access policy of the client and/or the data access policy of the user, if the distributed ledger can tamper with the data access policy, it is likely that some clients maliciously tamper with personal data access policies and modify permission of the clients, affecting data security. Therefore, the distributed ledger is tamper-proof. This helps improve security of the personal data of the user.

It should be further noted that the distributed ledger further stores a data access record of the client and/or a data access record of the user, and the data access record includes data access transaction information of each time of data access performed by the client, and a data storage address of the client and/or a data storage address of the user. The distributed ledger stores the data access record. This can help improve security of data access performed by the user.

405: The distributed ledger node generates a first access permission verification response if the client has the data access permission, where the first access permission verification response indicates that the client has the data access permission.

In a possible implementation, a specific implementation in which the distributed ledger node generates the first access permission verification response is: The distributed ledger node generates the first access permission verification response based on the smart contract, and sends the first access permission verification response to the data storage entity. Because the smart contract is traceable and irreversible, based on this implementation, security of data exchange between the data storage entity and the distributed ledger node can be improved.

406: The distributed ledger node sends the first access permission verification response to the data storage entity. Correspondingly, the data storage entity receives the first access permission verification response sent from the distributed ledger node.

In a possible implementation, the distributed ledger node generates a second access permission verification response if the client does not have the data access permission, where the second access permission verification response indicates that the client does not have the data access permission. After receiving the second access permission verification response, the distributed ledger node does not send corresponding data to the client. Optionally, corresponding punishment processing may be performed on the client. For example, any message sent by the client is no longer processed (or no longer processed within a preset time period). Based on this implementation, security of user data is improved.

407: The data storage entity sends, to the client, the data corresponding to the client.

In a possible implementation, after step 407, the method further includes: The data storage entity sends a data return success message to the distributed ledger node, where the data return success message carries the data access transaction information of the client. After receiving the data return success message sent by the data storage entity, the distributed ledger node records the data access transaction information of the client in the distributed ledger. The distributed ledger is tamper-proof. Based on this implementation, the distributed ledger of the distributed ledger platform stores information about data access performed by each client. This facilitates security of data access performed by the client.

Based on the method described above, in the data access process, the client does not directly perform exchange data with the distributed ledger platform through an interface. Therefore, a case in which the distributed ledger node receives permission verification requests sent from a large quantity of clients is reduced, and a possibility of a network attack on the distributed ledger platform is reduced, thereby helping improve the security of data access performed by the client.

FIG. 6 shows another data management method according to an embodiment of this application, and is mainly for describing data update performed by a client. The data management method includes step 601 to step 607. In FIG. 6, the client, a distributed ledger node, and a data storage entity are used as execution subjects for description.

601: The client sends a data update request to the data storage entity. Correspondingly, the data storage entity receives the data update request sent from the client.

In this embodiment of this application, the data update request indicates that the client requests to perform data update, and the data update request carries an identifier of the client and/or an identifier of a user, so that the data storage entity initiates an update permission verification request to the distributed ledger node based on the identifier of the client and/or the identifier of the user, to verify whether the client has data update permission. Optionally, the data update request may further carry a private key signature of the client and/or a data update policy of the client. Information carried in the data update request is mainly used by the distributed ledger node to determine an identity and the data update policy of the client, and indicate, according to the data update policy of the client, the data storage entity to update data corresponding to the client or reject a data access request.

Same as the identifier of the user described in step 401 in the foregoing figure, the identifier of the user may be an identifier of a user logging in to the client, or may be an identifier of a user logging in to a target device. The target device authorizes the client to update personal data. Therefore, the client may update data corresponding to the user by carrying the identifier of the user logging in to the target device. It should be further noted that, if the client needs to update data of the target device, in addition to the identifier of the user of the target device, the data update request further needs to carry a digital signature corresponding to the user of the target device, to ensure data security.

Based on the method described above, the client does not need to verify, through a distributed ledger platform, whether the client has the update permission. Instead, the client sends the data update request to the data storage entity, and the data storage entity requests the distributed ledger platform to verify whether the client has the update permission. The client does not directly exchange data with the distributed ledger platform through an interface. Therefore, a case in which the distributed ledger node receives permission verification requests sent from a large quantity of clients is reduced, and a possibility of a network attack on the distributed ledger platform is reduced, thereby helping improve security of data update performed by the client. In addition, because the data update request not only indicates that the client requests the update, but also indicates that the data storage entity is requested to initiate the update permission verification request to the distributed ledger node, to verify the identity of the client. The client no longer needs to send the update permission verification request to the distributed ledger node. This helps reduce a delay of data update performed by the client.

602: The data storage entity generates the update permission verification request based on the data update request.

In this embodiment of this application, when receiving a message that is sent from another device (the client or the data storage entity) and that is for requesting verification permission, the distributed ledger node first determines a type of a transaction based on the message, and then determines a control policy of a user or a control policy of a device in the distributed ledger based on an identifier of the user or an identifier of the device carried in the message, to determine whether the user or the device has corresponding permission on the transaction. Based on the method described in this application, the distributed ledger node receives the update permission verification request sent from the data storage entity, and the update permission verification request is generated based on the data update request sent by the client. Therefore, a transaction type corresponding to the update permission verification request is a data request.

Optionally, if the data update request further carries the private key signature of the client and/or the data update policy of the client, the update permission verification request further carries the private key signature of the client and/or the data update policy of the client.

In a possible implementation, a specific implementation in which the data storage entity generates the update permission verification request based on the data update request is: The data storage entity generates the update permission verification request based on a smart contract and the data update request. Because the smart contract is traceable and irreversible, based on this implementation, security of data exchange between the data storage entity and the distributed ledger node can be improved.

603: The data storage entity sends the update permission verification request to the distributed ledger node. Correspondingly, the distributed ledger node receives the update permission verification request sent from the data storage entity.

In this embodiment of this application, after receiving the update permission verification request sent from the data storage entity, the distributed ledger node verifies the transaction type corresponding to the update permission verification request. Because the update permission verification request is generated based on the data update request sent by the client, the transaction type corresponding to the update permission verification request is the data update.

The transaction type supported in this application is the same as the transaction type described in step 403. Details are not described in this embodiment of this application again.

604: The distributed ledger node verifies, based on the identifier of the client and/or the identifier of the user and a distributed ledger, whether the client has the data update permission.

In this embodiment of this application, the distributed ledger stores the data update policy of the client and/or a data update policy of the user. The distributed ledger node may be in one-to-one correspondence with information stored in the distributed ledger based on information carried in the update permission verification request. If the identifier of the client and/or the identifier of the user are/is completely the same as the information in the distributed ledger, and it is determined, in the data update policy, that the client has the data update permission, it is determined that the client has the data update permission. If the identifier of the client and/or the identifier of the user and the information in the distributed ledger have different content, or it is determined, in the data update policy, that the client does not have the data update permission, it is determined that the client does not have the data update permission.

The distributed ledger is tamper-proof. Because the distributed ledger stores the data update policy of the client and/or the data update policy of the user, if the distributed ledger can tamper with the data update policy, it is likely that some clients maliciously tamper with personal data update policies and modify permission of the clients, affecting data security. Therefore, the distributed ledger is tamper-proof. This helps improve security of the personal data of the user.

605: The distributed ledger node generates a first update permission verification response if the client has the data update permission, where the first update permission verification response indicates that the client has the data update permission.

In a possible implementation, a specific implementation in which the distributed ledger node generates the first update permission verification response is: The distributed ledger node generates the first update permission verification response based on the smart contract, and sends the first update permission verification response to the data storage entity. Because the smart contract is traceable and irreversible, based on this implementation, security of data exchange between the data storage entity and the distributed ledger node can be improved.

606: The distributed ledger node sends the first update permission verification response to the data storage entity. Correspondingly, the data storage entity receives the first update permission verification response sent from the distributed ledger node.

In a possible implementation, the distributed ledger node generates a second update permission verification response if the client does not have the data update permission, where the second update permission verification response indicates that the client does not have the data update permission. After receiving the second access permission verification response, the distributed ledger node does not send corresponding data to the client. Optionally, corresponding punishment processing may be performed on the client. For example, any message sent by the client is no longer processed (or no longer processed within a preset time period). Based on this implementation, security of user data is improved.

607: The data storage entity updates the data corresponding to the client.

In a possible implementation, after step 607, the method further includes: The data storage entity sends a data return success message to the distributed ledger node, where the data return success message carries data update transaction information of the client. After receiving the data return success message sent by the data storage entity, the distributed ledger node records the data update transaction information of the client in the distributed ledger. The distributed ledger is tamper-proof. Based on this implementation, the distributed ledger of the distributed ledger platform stores information about data update performed by each client. This facilitates security of data update performed by the client.

Based on the method described above, in a data update process, the client does not directly exchange data with the distributed ledger platform through an interface. Therefore, a case in which the distributed ledger node receives permission verification requests sent from a large quantity of clients is reduced, and a possibility of a network attack on the distributed ledger platform is reduced, thereby helping improve security of data update performed by the client.

FIG. 7 is a diagram of a structure of a communication apparatus according to an embodiment of this application. The communication apparatus shown in FIG. 7 may include a communication unit 701 and a processing unit 702. The processing unit 702 is configured to process data. A receiving unit and a sending unit are integrated into the communication unit 701. The communication unit 701 may also be referred to as a transceiver unit. Alternatively, the communication unit 701 may be split into a receiving unit and a sending unit. The following describes the two units in detail.

In an embodiment, the communication unit 701 is configured to receive a data access request sent from a client. The processing unit 702 is configured to generate an access permission verification request based on the data access request. The communication unit 701 is further configured to send an access permission verification request to a distributed ledger node, where the access permission verification request is for verifying whether the client has data access permission, and the access permission verification request carries an identifier of the client and/or an identifier of a user. The communication unit 701 is further configured to receive a first access permission verification response sent from the distributed ledger node, where the first access permission verification response indicates that the client has the data access permission. The communication unit 701 is further configured to send corresponding data to the client.

In a possible implementation, the communication unit 701 is further configured to send a data return success message to the distributed ledger node, where the data return success message carries data access transaction information of the client.

In a possible implementation, when generating the access permission verification request based on the data access request, the processing unit 702 is specifically configured to generate the access permission verification request based on a smart contract and the data access request.

In a possible implementation, the communication unit 701 is further configured to receive a data update request sent from the client. The processing unit 702 is further configured to generate an update permission verification request based on the data update request. The communication unit 701 is further configured to send the update permission verification request to the distributed ledger node, where the update permission verification request is for verifying whether the client has data update permission, and the update permission verification request carries the identifier of the client and/or the identifier of the user. The communication unit 701 is further configured to receive a first update permission verification response sent from the distributed ledger node, where the first update permission verification response indicates that the client has the data update permission. The processing unit 702 is further configured to update the data corresponding to the client.

Specifically, for operations performed by the units of the communication apparatus shown in FIG. 7, refer to related content of the data storage entity in the method embodiment corresponding to FIG. 4 or FIG. 6. Details are not described herein again. The foregoing units may be implemented through hardware, software, or a combination of software and hardware. In a possible implementation, functions of the communication unit 701 and the processing unit 702 in the foregoing content may be implemented by one or more processors in the communication apparatus.

In this embodiment, the communication apparatus receives the data access request sent from the client, and then sends the access permission verification request to the distributed ledger node, so that the client no longer needs to request access permission verification from the distributed ledger node. This avoids a case in which the distributed ledger node receives access permission requests sent from a large quantity of clients, so as to avoid a network attack on a distributed ledger platform, and improve security of data access performed by the client.

In still another embodiment, the communication unit 701 is configured to receive an access permission verification request sent from a data storage entity, where the access permission verification request is for verifying whether a client has data access permission, and the access permission verification request carries an identifier of the client and/or an identifier of a user. The processing unit 702 is configured to verify, based on the identifier of the client and/or the identifier of the user and a distributed ledger, whether the client has the data access permission, where the distributed ledger stores a data access policy of the client and/or a data access policy of the user. The communication unit 701 is further configured to send a first access permission verification response to the data storage entity if the client has the data access permission, where the first access permission verification response indicates that the client has the data access permission.

In a possible implementation, the communication unit 701 is further configured to receive, from the distributed ledger node, a data return success message sent by the data storage entity, where the data return success message carries data access transaction information of the client. The processing unit 702 is further configured to record the data access transaction information of the client in the distributed ledger.

In a possible implementation, when the distributed ledger node sends the first access permission verification response to the data storage entity if the client has the data access permission, the communication unit 701 is specifically configured to: if the client has the data access permission, and the distributed ledger node generates the first access permission verification response based on a smart contract, send the first access permission verification response to the data storage entity.

In a possible implementation, the communication unit 701 is further configured to send a second access permission verification response to the data storage entity if the client does not have the data access permission, where the second access permission verification response indicates that the client does not have the data access permission.

In a possible implementation, the communication unit 701 is further configured to receive an update permission verification request sent from the data storage entity, where the update permission verification request is for verifying whether the client has data update permission, and the update permission verification request carries the identifier of the client and/or the identifier of the user. The processing unit 702 is further configured to verify, based on the identifier of the client and/or the identifier of the user and the distributed ledger, whether the client has the data update permission, where the distributed ledger stores a data update policy of the client and/or a data update policy of the user. The communication unit 701 is further configured to send a first update permission verification response to the data storage entity if the client has the data update permission, where the first update permission verification response indicates that the client has the data update permission.

Specifically, for operations performed by the units of the communication apparatus shown in FIG. 7, refer to related content of the distributed ledger node in the method embodiment corresponding to FIG. 4 or FIG. 6. Details are not described herein again. The foregoing units may be implemented through hardware, software, or a combination of software and hardware. In a possible implementation, functions of the communication unit 701 and the processing unit 702 in the foregoing content may be implemented by one or more processors in the communication apparatus.

In this embodiment, the communication apparatus only needs to receive an access permission request sent from the data storage entity, and does not need to receive an access permission request sent from the client. This avoids a case in which access permission requests sent from a large quantity of clients are received. Compared with the client, a quantity of data storage entities is greatly reduced, and security is high. In this way, security of data access performed by the client can be improved.

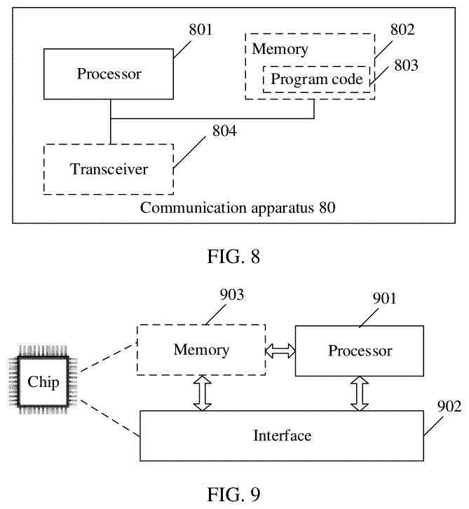

FIG. 8 is a diagram of a structure of another communication apparatus according to an embodiment of this application. The communication apparatus 80 may be configured to implement the method described in the foregoing method embodiments. For details, refer to the descriptions in the foregoing method embodiments.

The communication apparatus 80 may include one or more processors 801. The processor 801 may be a general-purpose processor, a dedicated processor, or the like. The processor 801 may be configured to: control the communication apparatus 80, execute a software program, and process data of the software program.

Optionally, the communication apparatus 80 may include one or more memories 802. The memory 802 may store program code 803. The program code may be run on the processor 801, so that the communication apparatus 80 performs the method described in the foregoing method embodiments. Optionally, the memory 802 may further store data. The processor 801 and the memory 802 may be separately disposed, or may be integrated together. Optionally, the memory 802 may alternatively be located outside the communication apparatus 80, and is coupled to the communication apparatus 80 in some manners.

Optionally, the communication apparatus 80 may further include a transceiver 804. The transceiver 804 may be referred to as a transceiver unit, a transceiver machine, a transceiver circuit, or the like, and is configured to implement a transceiver function. The transceiver 804 may include a receiver and a transmitter. The receiver may be referred to as a receiver machine, a receiver circuit, or the like, and is configured to implement a receiving function. The transmitter may be referred to as a transmitter machine, a transmitter circuit, or the like, and is configured to implement a sending function.

In an embodiment, the processor 801 is configured to receive a data access request sent from a client, and generate an access permission verification request based on the data access request.

The processor 801 is further configured to send the access permission verification request to a distributed ledger node, where the access permission verification request is for verifying whether the client has data access permission, and the access permission verification request carries an identifier of the client and/or an identifier of a user.

The processor 801 is further configured to receive a first access permission verification response sent from the distributed ledger node, where the first access permission verification response indicates that the client has the data access permission.

The processor 801 is further configured to send corresponding data to the client.

In a possible implementation, the processor 801 is further configured to invoke the program code 803 from the memory 802 to perform the following operation: sending a data return success message to the distributed ledger node, where the data return success message carries data access transaction information of the client.

In a possible implementation, when generating the access permission verification request based on the data access request, the processor 801 is specifically configured to generate the access permission verification request based on a smart contract and the data access request.

In a possible implementation, the processor 801 is further configured to invoke the program code 803 from the memory 802 to perform the following operations: receiving a data update request sent from the client; generating an update permission verification request based on the data update request; sending the update permission verification request to the distributed ledger node, where the update permission verification request is for verifying whether the client has data update permission, and the update permission verification request carries the identifier of the client and/or the identifier of the user; receiving a first update permission verification response sent from the distributed ledger node, where the first update permission verification response indicates that the client has the data update permission; and updating the data corresponding to the client.

Specifically, for operations performed by the communication apparatus 80, refer to related content of the data storage entity in the foregoing method embodiment corresponding to FIG. 4 or FIG. 6. Details are not described herein again.

In this embodiment, the communication apparatus 80 receives the data access request sent from the client, and then sends the access permission verification request to the distributed ledger node, so that the client no longer needs to request access permission verification from the distributed ledger node. This avoids a case in which the distributed ledger node receives access permission requests sent from a large quantity of clients, so as to avoid a network attack on a distributed ledger platform, and improve security of data access performed by the client.

In still another embodiment, the processor 801 is configured to receive an access permission verification request sent from a data storage entity, where the access permission verification request is for verifying whether a client has data access permission, and the access permission verification request carries an identifier of the client and/or an identifier of a user.

The processor 801 is further configured to verify, based on the identifier of the client and/or the identifier of the user and a distributed ledger, whether the client has the data access permission, where the distributed ledger stores a data access policy of the client and/or a data access policy of the user.

The processor 801 is further configured to send a first access permission verification response to the data storage entity if the client has the data access permission, where the first access permission verification response indicates that the client has the data access permission.

In a possible implementation, the processor 801 is further configured to invoke the program code 803 from the memory 802 to perform the following operation: after receiving a data return success message sent by the data storage entity, where the data return success message carries data access transaction information of the client, recording the data access transaction information of the client in the distributed ledger.

In a possible implementation, when the distributed ledger node sends the first access permission verification response to the data storage entity if the client has the data access permission, the processor 801 is specifically configured to: if the client has the data access permission, and the distributed ledger node generates the first access permission verification response based on a smart contract, send the first access permission verification response to the data storage entity.

In a possible implementation, the processor 801 is further configured to invoke the program code 803 from the memory 802 to perform the following operation: sending a second access permission verification response to the data storage entity if the client does not have the data access permission, where the second access permission verification response indicates that the client does not have the data access permission.

In a possible implementation, the processor 801 is further configured to invoke the program code 803 from the memory 802 to perform the following operations: receiving an update permission verification request sent from the data storage entity, where the update permission verification request is for verifying whether the client has data update permission, and the update permission verification request carries the identifier of the client and/or the identifier of the user; verifying, based on the identifier of the client and/or the identifier of the user and the distributed ledger, whether the client has the data update permission, where the distributed ledger stores a data update policy of the client and/or a data update policy of the user; and sending a first update permission verification response to the data storage entity if the client has the data update permission, where the first update permission verification response indicates that the client has the data update permission.

Specifically, for operations performed by the communication apparatus 80, refer to related content of the distributed ledger node in the method embodiment corresponding to FIG. 4 or FIG. 6. Details are not described herein again.

In this embodiment, the communication apparatus 80 only needs to receive an access permission request sent from the data storage entity, and does not need to receive an access permission request sent from the client. This avoids a case in which access permission requests sent from a large quantity of clients are received. Compared with the client, a quantity of data storage entities is greatly reduced, and security is high. In this way, security of data access performed by the client can be improved.

In another possible design, the transceiver may be a transceiver circuit, an interface, or an interface circuit. The transceiver circuit, the interface, or the interface circuit configured to implement the receiving and sending functions may be separated, or may be integrated together. The transceiver circuit, the interface, or the interface circuit may be configured to read and write code/data. Alternatively, the transceiver circuit, the interface, or the interface circuit may be configured to transmit or transfer a signal.

In still another possible design, the communication apparatus 80 may include a circuit. The circuit may implement a sending, receiving, or communication function in the foregoing method embodiments. The processor and the transceiver described in this embodiment of this application may be implemented on an integrated circuit (integrated circuit, IC), an analog IC, a radio frequency integrated circuit RFIC, a hybrid signal IC, an application-specific integrated circuit (application-specific integrated circuit, ASIC), a printed circuit board (printed circuit board, PCB), an electronic device, or the like.

The communication apparatus described in the foregoing embodiments may be a terminal device or a network device. However, a scope of the communication apparatus described in embodiments of this application is not limited thereto, and a structure of the communication apparatus may not be limited by FIG. 8. The communication apparatus may be an independent device or may be a part of a large device. For example, the communication apparatus may be:
(1) an independent integrated circuit IC, a chip, or a chip system or subsystem;
(2) a set that has one or more ICs, where optionally, the IC set may alternatively include a storage component configured to store data and instructions;
(3) ASIC, for example, a modem (MSM);
(4) a module that can be embedded in another device;
(5) a receiver machine, a terminal, an intelligent terminal, a cellular phone, a wireless device, a handheld device, a mobile unit, a vehicle-mounted device, a network device, a cloud device, an artificial intelligence device, or the like; or
(6) others.

For a case in which the communication apparatus may be a chip or a chip system, refer to a diagram of a structure of a chip in FIG. 9. The chip shown in FIG. 9 includes a processor 901 and an interface 902. Optionally, the chip may further include a memory 903. There may be one or more processors 901 and a plurality of interfaces 902.

In a design, when the chip is configured to implement functions of a terminal device in embodiments of this application, the interface 902 is configured to receive or output a signal.

The processor 901 is configured to perform a data processing operation performed by the terminal device in the foregoing method embodiments.

In another design, when the chip is configured to implement functions of a network device in embodiments of this application, the interface 902 is configured to receive or output a signal.

The processor 901 is configured to perform a data processing operation performed by the network device in the foregoing method embodiments.

It may be understood that in some scenarios, some optional features in embodiments of this application may be independently implemented without depending on another feature, for example, a solution on which the optional features are currently based, to resolve a corresponding technical problem and achieve corresponding effects. Alternatively, in some scenarios, the optional features may be combined with other features based on a requirement. Correspondingly, the communication apparatus provided in embodiments of this application may also correspondingly implement these features or functions. Details are not described herein.

It should be noted that the processor in embodiments of this application may be an integrated circuit chip, and has a signal processing capability. In an implementation process, steps in the foregoing method embodiments can be implemented by using a hardware integrated logical circuit in the processor, or by using instructions in a form of software. The foregoing processor may be a general-purpose processor, a digital signal processor (digital signal processor, DSP), an application-specific integrated circuit (application-specific integrated circuit, ASIC), a field programmable gate array (field programmable gate array, FPGA) or another programmable logic device, a discrete gate or transistor logic device, or a discrete hardware component.

It may be understood that the memory in embodiments of this application may be a volatile memory or a non-volatile memory, or may include a volatile memory and a non-volatile memory. The non-volatile memory may be a read-only memory (read-only memory, ROM), a programmable read-only memory (programmable ROM, PROM), an erasable programmable read-only memory (erasable PROM, EPROM), an electrically erasable programmable read-only memory (electrically EPROM, EEPROM), or a flash memory. The volatile memory may be a random access memory (random access memory, RAM), used as an external cache. Through example but not limitative description, many forms of RAMs may be used, for example, a static random access memory (static RAM, SRAM), a dynamic random access memory (dynamic RAM, DRAM), a synchronous dynamic random access memory (synchronous DRAM, SDRAM), a double data rate synchronous dynamic random access memory (double data rate SDRAM, DDR SDRAM), an enhanced synchronous dynamic random access memory (enhanced SDRAM, ESDRAM), a synchlink dynamic random access memory (synchlink DRAM, SLDRAM), and a direct rambus random access memory (direct rambus RAM, DR RAM). It should be noted that the memory of the systems and methods described in this specification includes but is not limited to these and any memory of another proper type.

This application further provides a computer-readable medium, configured to store computer software instructions. When the instructions are executed by a communication apparatus, the function in any one of the foregoing method embodiments is implemented.

This application further provides a computer program product, configured to store computer software instructions. When the instructions are executed by a communication apparatus, the function in any one of the foregoing method embodiments is implemented.

All or some of the foregoing embodiments may be implemented by using software, hardware, firmware, or any combination thereof. When the software is used to implement embodiments, all or some of embodiments may be implemented in a form of a computer program product. The computer program product includes one or more computer instructions. When the computer instructions are loaded and executed on a computer, all or some of the procedures or functions according to embodiments of this application are generated. The computer may be a general-purpose computer, a dedicated computer, a computer network, or another programmable apparatus. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (digital subscriber line, DSL)) or wireless (for example, infrared, radio, or microwave) manner. The computer-readable storage medium may be any usable medium accessible by the computer, or a data storage device, for example, a server or a data center, integrating one or more usable media. The usable medium may be a magnetic medium (for example, a floppy disk, a hard disk, or a magnetic tape), an optical medium (for example, a high-density digital video disc (digital video disc, DVD)), a semiconductor medium (for example, a solid-state disk (solid-state disk, SSD)), or the like.

An embodiment of this application further provides a computer program product. When the computer program product runs on a processor, method procedures in the foregoing method embodiments are implemented.

Descriptions of embodiments provided in this application may refer to each other, and the descriptions of embodiments have respective focuses. For a part that is not described in detail in an embodiment, refer to related descriptions in another embodiment. For ease of description and brevity, for functions of the apparatuses and devices provided in embodiments of this application and operations performed by the apparatuses and devices, refer to related descriptions of the method embodiments of this application. The method embodiments and the apparatus embodiments may also be mutually referenced, combined, or cited.

In the foregoing embodiments, the descriptions of embodiments have respective focuses. For a part that is not described in detail in an embodiment, refer to related descriptions in another embodiment.

Finally, it should be noted that the foregoing embodiments are merely intended for describing the technical solutions of this application other than limiting this application. Although this application is described in detail with reference to the foregoing embodiments, persons of ordinary skill in the art should understand that they may still make modifications to the technical solutions described in the foregoing embodiments or make equivalent replacements to some or all technical features thereof, without departing from the scope of the technical solutions of embodiments of this application.

1. A data management method, wherein the method comprises:
receiving, by a data storage entity, a data access request sent from a client;
generating, by the data storage entity, an access permission verification request based on the data access request, and sending the access permission verification request to a distributed ledger node, wherein the access permission verification request is for verifying whether the client has data access permission, and the access permission verification request carries an identifier of the client and/or an identifier of a user;
receiving, by the data storage entity, a first access permission verification response sent from the distributed ledger node, wherein the first access permission verification response indicates that the client has the data access permission; and
sending, by the data storage entity, corresponding data to the client.

2. The method according to claim 1, wherein the method further comprises:
sending, by the data storage entity, a data return success message to the distributed ledger node, wherein the data return success message carries data access transaction information of the client.

3. The method according to claim 1, wherein the generating, by the data storage entity, an access permission verification request based on the data access request comprises:
generating, by the data storage entity, the access permission verification request based on a smart contract and the data access request.

4. The method according to claim 1, wherein the method further comprises:
receiving, by the data storage entity, a data update request sent from the client;
generating, by the data storage entity, an update permission verification request based on the data update request, and sending the update permission verification request to the distributed ledger node, wherein the update permission verification request is for verifying whether the client has data update permission, and the update permission verification request carries the identifier of the client and/or the identifier of the user;
receiving, by the data storage entity, a first update permission verification response sent from the distributed ledger node, wherein the first update permission verification response indicates that the client has the data update permission; and
updating, by the data storage entity, the data corresponding to the client.

5. A data management method, wherein the method comprises:
receiving, by a distributed ledger node, an access permission verification request sent from a data storage entity, wherein the access permission verification request is for verifying whether a client has data access permission, and the access permission verification request carries an identifier of the client and/or an identifier of a user;
verifying, by the distributed ledger node based on the identifier of the client and/or the identifier of the user and a distributed ledger, whether the client has the data access permission, wherein the distributed ledger stores a data access policy of the client and/or a data access policy of the user; and
sending, by the distributed ledger node, a first access permission verification response to the data storage entity in response to the client has the data access permission, wherein the first access permission verification response indicates that the client has the data access permission.

6. The method according to claim 5, wherein the method further comprises:
receiving, by the distributed ledger node, a data return success message sent by the data storage entity, wherein the data return success message carries data access transaction information of the client; and
recording, by the distributed ledger node, the data access transaction information of the client in the distributed ledger.

7. The method according to claim 5, wherein the sending, by the distributed ledger node, a first access permission verification response to the data storage entity in response to the client has the data access permission comprises:
generating, by the distributed ledger node, the first access permission verification response based on a smart contract in response to the client has the data access permission; and
sending, by the distributed ledger node, the first access permission verification response to the data storage entity.

8. The method according to claim 5, wherein the method further comprises:
sending, by the distributed ledger node, a second access permission verification response to the data storage entity in response to the client does not have the data access permission, wherein the second access permission verification response indicates that the client does not have the data access permission.

9. The method according to claim 5, wherein the method further comprises:
receiving, by the distributed ledger node, an update permission verification request sent from the data storage entity, wherein the update permission verification request is for verifying whether the client has data update permission, and the update permission verification request carries the identifier of the client and/or the identifier of the user;
verifying, by the distributed ledger node based on the identifier of the client and/or the identifier of the user and the distributed ledger, whether the client has the data update permission, wherein the distributed ledger stores a data update policy of the client and/or a data update policy of the user; and
sending a first update permission verification response to the data storage entity in response to the client has the data update permission, wherein the first update permission verification response indicates that the client has the data update permission.

10. A communication apparatus, comprising a processor coupled to a memory storing instructions, which when executed by the processor, cause the communication apparatus to:
receive a data access request sent from a client;
generate an access permission verification request based on the data access request, and sending the access permission verification request to a distributed ledger node, wherein the access permission verification request is for verifying whether the client has data access permission, and the access permission verification request carries an identifier of the client and/or an identifier of a user;
receive a first access permission verification response sent from the distributed ledger node, wherein the first access permission verification response indicates that the client has the data access permission; and
send corresponding data to the client.

11. The communication apparatus according to claim 10, wherein when the instructions are executed by the processor, the communication apparatus is further caused to:
send a data return success message to the distributed ledger node, wherein the data return success message carries data access transaction information of the client.

12. The communication apparatus according to claim 10, wherein the generating an access permission verification request based on the data access request comprises:
generating the access permission verification request based on a smart contract and the data access request.

13. The communication apparatus according to claim 10, wherein when the instructions are executed by the processor, the communication apparatus is further caused to:
receive a data update request sent from the client;
generate an update permission verification request based on the data update request, and sending the update permission verification request to the distributed ledger node, wherein the update permission verification request is for verifying whether the client has data update permission, and the update permission verification request carries the identifier of the client and/or the identifier of the user;
receive a first update permission verification response sent from the distributed ledger node, wherein the first update permission verification response indicates that the client has the data update permission; and
update the data corresponding to the client.

14. A communication apparatus, comprising a processor coupled to a memory storing instructions, which when executed by the processor, cause the communication apparatus to:
receive an access permission verification request sent from a data storage entity, wherein the access permission verification request is for verifying whether a client has data access permission, and the access permission verification request carries an identifier of the client and/or an identifier of a user;
verify based on the identifier of the client and/or the identifier of the user and a distributed ledger, whether the client has the data access permission, wherein the distributed ledger stores a data access policy of the client and/or a data access policy of the user; and
send a first access permission verification response to the data storage entity in response to the client has the data access permission, wherein the first access permission verification response indicates that the client has the data access permission.

15. The communication apparatus according to claim 14, wherein when the instructions are executed by the processor, the communication apparatus is further caused to:
receive a data return success message sent by the data storage entity, wherein the data return success message carries data access transaction information of the client; and
record the data access transaction information of the client in the distributed ledger.

16. The communication apparatus according to claim 14, wherein the sending a first access permission verification response to the data storage entity in response to the client has the data access permission comprises:
generating the first access permission verification response based on a smart contract in response to the client has the data access permission; and
sending the first access permission verification response to the data storage entity.

17. The communication apparatus according to claim 14, wherein when the instructions are executed by the processor, the communication apparatus is further caused to:
send a second access permission verification response to the data storage entity in response to the client does not have the data access permission, wherein the second access permission verification response indicates that the client does not have the data access permission.

18. The communication apparatus according to claim 14, wherein when the instructions are executed by the processor, the communication apparatus is further caused to:
receive an update permission verification request sent from the data storage entity, wherein the update permission verification request is for verifying whether the client has data update permission, and the update permission verification request carries the identifier of the client and/or the identifier of the user;
verify based on the identifier of the client and/or the identifier of the user and the distributed ledger, whether the client has the data update permission, wherein the distributed ledger stores a data update policy of the client and/or a data update policy of the user, and
send a first update permission verification response to the data storage entity in response to the client has the data update permission, wherein the first update permission verification response indicates that the client has the data update permission.
